(19) United States
(12) Patent Application Publication
(10) Pub. No.: US 2026/0319825 A1
(43) Pub. Date: Oct. 15, 2026

(54) OPERATION CONTROL DEVICE, STORAGE MEDIUM STORING OPERATION CONTROL PROGRAM, AND ELECTRONIC CONTROL UNIT

(71) Applicants: DENSO CORPORATION, Kariya-city (JP); eSOL Co., Ltd., Tokyo (JP)

(72) Inventors: Hiroki TSUDA, Kariya-city (JP); Manabu OOI, Tokyo (JP); Daigo NAKAYAMA, Tokyo (JP); Kosuke NISHIJO, Tokyo (JP)

(21) Appl. No.: 19/687,744

(22) Filed: May 26, 2026

Related U.S. Application Data
(63) Continuation of application No. PCT/JP2024/038347, filed on Oct. 28, 2024.

(30) Foreign Application Priority Data
Nov. 28, 2023 (JP) 2023-200713

(51) Int. Cl. G06F 9/455

(52) U.S. Cl. CPC G06F 9/45558; G06F 2009/4557; G06F 2009/45575; G06F 2009/45591

(57) ABSTRACT

An operation control device performs control for operating each virtual machine in a time-division manner, and includes a first processing unit configured to execute a switching process of switching the operating machine; and a second processing unit configured to execute a prohibition process for the switching process and a permission process for the switching process. The operating machine transmits a prohibition request and a permission request. The second processing unit determines whether a remaining time is equal to or longer than a predetermined set time. The second processing unit executes the prohibition process when the remaining time is equal to or longer than the set time, and does not execute the prohibition process when the remaining time is less than the set time.

### CROSS REFERENCE TO RELATED APPLICATIONS

The present application is a continuation application of International Patent Application No. PCT/JP2024/038347 filed on Oct. 28, 2024, which designated the U.S. and claims the benefit of priority from Japanese Patent Application No. 2023-200713 filed on Nov. 28, 2023. The entire disclosures of all of the above applications are incorporated herein by reference.

### TECHNICAL FIELD

The present disclosure relates to an operation control device configured to perform control for operating each of multiple virtual machines in a time-division manner by an operation time allocated in advance for each operation cycle, an operation control program to be executed by the operation control device, and an electronic control unit including the operation control device.

### BACKGROUND

For example, multiple electronic control units are mounted on a vehicle such as an automobile, and the multiple electronic control units communicate with each other to execute various types of processes in cooperation with each other. In the present specification, the electronic control unit may be abbreviated as an ECU. In recent years, since the number of ECUs mounted on a vehicle tends to increase, a method of integrating multiple ECUs into one has been implemented. In the integrated ECU, which is an ECU integrated in this manner, functions of multiple ECUs that have conventionally operated independently are mounted as multiple virtual machines on a single microcomputer via a hypervisor.

In the conventional ECU, resources of one microcomputer can be occupied by a function of one ECU, but in the integrated ECU, resources of one microcomputer are used by each of the multiple virtual machines. Therefore, in the integrated ECU, control is performed by time-division scheduling that allocates a fixed operation time to the multiple virtual machines. By the time-division scheduling, each of the multiple virtual machines operates individually by the operation time allocated in advance, so that it is not necessary to allocate resources in cooperation among the virtual machines.

In the above configuration, when a predetermined virtual machine operates, a switching process of switching the operating virtual machine is executed at a stage where the operation time is consumed. That is, in the above configuration, there is a possibility that the switching process is executed regardless of whether the processing in operation is completed. Therefore, in the above configuration, the switching process is executed during execution of a process that must be continuously executed, that is, an uninterruptible process or an atomic process, and as a result, a difficulty arises in that the uninterruptible process or the like is interrupted.

Comparative technologies related to such a difficulty have been known. First, a method of dividing tasks into several groups and adaptively time-dividing processing times of the groups has been known as a first comparative example. Subsequently, a method of guaranteeing an uninterruptible process has been known as a second comparative example, by detecting and disabling an interrupt task when the interrupt task occurs during the uninterruptible process, and executing the interrupt task after the uninterruptible process is completed.

### SUMMARY

According to an aspect of the present disclosure, an operation control device may perform control for operating each virtual machine in a time-division manner, and include a first processing unit configured to execute a switching process of switching the operating machine; and a second processing unit configured to execute a prohibition process for the switching process and a permission process for the switching process. The operating machine may transmit a prohibition request and a permission request. The second processing unit may determine whether a remaining time is equal to or longer than a predetermined set time. The second processing unit may execute the prohibition process when the remaining time is equal to or longer than the set time, and may not execute the prohibition process when the remaining time is less than the set time.

### BRIEF DESCRIPTION OF DRAWINGS

FIG. 1 is a schematic diagram showing a configuration of an integrated ECU and an ECU according to a first embodiment.

FIG. 2 is a timing chart showing an operation content of each unit in a first comparative operation example according to a comparative example.

FIG. 3 is a timing chart showing an operation content of each unit in a second comparative operation example according to the comparative example.

FIG. 4 is a timing chart showing an operation content of each unit in a first operation example according to the first embodiment.

FIG. 5 is a timing chart showing an operation content of each unit in a second operation example according to the first embodiment.

FIG. 6 is a timing chart showing an operation content of each unit in a third operation example according to the first embodiment.

FIG. 7 is a timing chart showing an operation content of each unit in a fourth operation example according to the first embodiment.

FIG. 8 is a timing chart showing an operation content of each unit in a fifth operation example according to the first embodiment.

FIG. 9 is a timing chart showing an operation content of each unit in a sixth operation example according to the first embodiment.

FIG. 10 is a timing chart showing an operation content of each unit in a seventh operation example according to the first embodiment.

FIG. 11 is a timing chart showing an operation content of each unit in an eighth operation example according to the first embodiment.

FIG. 12 is a timing chart showing an operation content of each unit in a ninth operation example according to the first embodiment.

FIG. 13 is a timing chart showing an operation content of each unit in a third comparative operation example according to the comparative example.

FIG. 14 is a timing chart showing an operation content of each unit in a tenth operation example according to the first embodiment.

FIG. 15 is a timing chart showing an operation content of each unit in a fourth comparative operation example according to the comparative example.

FIG. 16 is a timing chart showing an operation content of each unit in a fifth comparative operation example according to the comparative example.

FIG. 17 is a timing chart showing an operation content of each unit in an eleventh operation example according to the first embodiment.

FIG. 18 is a diagram showing a specific example regarding allocation of a total margin time according to the first embodiment.

FIG. 19 is a schematic diagram showing an example of specific contents of each process executed when a prohibition request is received according to the first embodiment.

FIG. 20 is a schematic diagram showing an example of specific contents of each process executed in a prohibition period according to the first embodiment.

FIG. 21 is a schematic diagram showing an example of specific contents of each process executed when an operation time according to a modification ends.

FIG. 22 is a schematic diagram showing an example of specific contents of each process executed when a permission request is received according to the first embodiment.

FIG. 23 is a timing chart showing an operation content of each unit in a twelfth operation example according to a second embodiment.

FIG. 24 is a timing chart showing an operation content of each unit in a thirteenth operation example according to the second embodiment.

FIG. 25 is a timing chart showing an operation content of each unit in a fourteenth operation example according to the second embodiment.

FIG. 26 is a timing chart showing an operation content of each unit in a fifteenth operation example according to a third embodiment.

### DETAILED DESCRIPTION

In the first comparative technology, an uninterruptible process is not taken into consideration. Further, in the second comparative technology, it is not possible to take into consideration a process known in advance to cause an interrupt, such as a switching process for switching an operating virtual machine, and a possibility that an interrupt task is not executed without completion of an uninterruptible process. For this reason, in the comparative technologies, it is difficult to solve the above-described difficulty.

An aspect of the present disclosure provides an operation control device, an operation control program, and an electronic control unit capable of preventing a process that must be continuously executed from being interrupted by a switching process.

According to the aspect of the present disclosure, an operation control device performs control for operating each of multiple virtual machines in a time-division manner by an operation time allocated in advance for each operation cycle. In this case, an operating virtual machine among the multiple virtual machines is defined as an operating machine. The operation control device includes: a first processing unit capable of executing the switching process of switching the operating machine; and a second processing unit capable of executing the prohibition process of prohibiting execution of the switching process and the permission process of permitting execution of the switching process. The operating machine transmits a prohibition request when starting a specific process, which is a process that has to be continuously executed, that is, an uninterruptible process or an atomic process, and transmits a permission request when completing the specific process.

When receiving the prohibition request, the second processing unit executes a determination process of determining whether a remaining time, which is a time from the reception time to a time when the operation time elapses, is equal to or longer than a predetermined set time. As a result of the determination process, the second processing unit executes the prohibition process when the remaining time is equal to or longer than the set time, and does not execute the prohibition process when the remaining time is less than the set time. In addition, when receiving the permission request, the second processing unit executes the permission process. The operating machine executes the specific process during a prohibition period, which is a period during which the prohibition process is executed.

According to the above configuration, it is possible to prevent the switching process for switching the operating machine from occurring while the operating machine is executing the specific process. Thereby, it is possible to guarantee consistent operation until the specific process is completed. Further, according to the above configuration, the second processing unit executes the determination process. Thus, when the remaining time is less than the set time, in other words, when there is an extremely low possibility that the specific process to be started from the current time can be completed by the time the operation time elapses, the prohibition process is not executed, and accordingly, the specific process is not executed. Thereby, it is possible to execute the specific process that is not expected to be completed in the operation cycle in the next operation cycle. Thus, according to the above configuration, it is possible to obtain an excellent effect of preventing the specific process, which is a process that has to be continuously executed, from being interrupted by the switching process.

Multiple embodiments will be described below with reference to the drawings. In each embodiment, substantially the same configurations are denoted by the same reference numerals, and description thereof will be omitted.

### First Embodiment

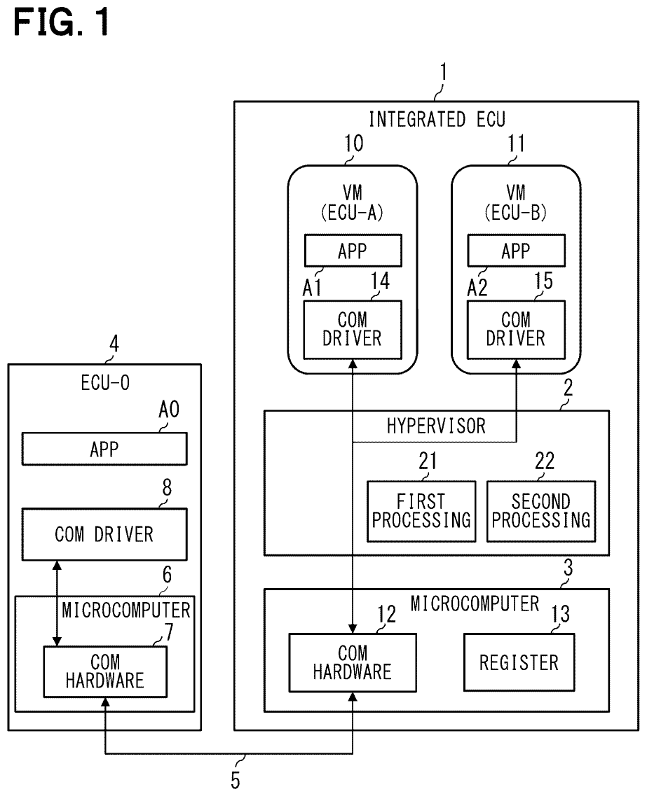

A first embodiment will be described below with reference to FIGS. 1 to 22.

As shown in FIG. 1, an integrated ECU (electronic control unit) 1 of the present embodiment is mounted on a vehicle such as an automobile, for example, and functions of multiple ECUs that have conventionally operated independently are mounted on a chip of a single microcomputer 3 via a hypervisor 2. Specific examples of the multiple ECUs include an engine ECU, an air conditioner ECU, a central gateway ECU, and a body ECU. In this case, the functions of the multiple ECUs are mounted in units of virtual machines. In the present specification, the hypervisor may be abbreviated as an HV, and the virtual machine may be abbreviated as a VM.

The integrated ECU 1 includes functions corresponding to two ECUs, ECU-A and ECU-B. The integrated ECU 1 may include functions corresponding to three or more ECUs. An ECU 4 is not integrated as the integrated ECU 1, but is provided independently similarly to a conventional ECU. The integrated ECU 1 and the ECU 4 are connected via a bus communication line 5, and thereby can communicate with each other. In the drawings, the term of “communication” may be also referred to as “COM”.

The ECU 4 includes a microcomputer 6. The microcomputer 6 includes a CPU (not shown), various storage devices, various peripherals, and the like as its hardware. The various peripherals include a communication hardware 7 for performing communication. In the present specification, hardware may be abbreviated as HW. The ECU 4 includes an ECU-0 application A0 for implementing its main function. In the present specification, an application may be abbreviated as an app. In the following description and drawings, the ECU-0 app A0 may be abbreviated as an app A0.

The ECU 4 includes a communication driver 8. The communication driver 8 controls the communication HW 7 to perform data communication with other ECUs including the integrated ECU 1 via the bus communication line 5. Both the app A0 and the communication driver 8 are implemented by the CPU included in the microcomputer 6 executing a computer program stored in a non-transitory tangible storage medium and executing a process corresponding to the computer program, that is, implemented by software.

The integrated ECU 1 includes two VMs 10 and 11. In this case, the function of the ECU-A is implemented by the VM 10, and the function of the ECU-B is implemented by the VM 11. The VM 10 includes an ECU-A app A1 for implementing a main function of the ECU-A. The VM 11 includes an ECU-B app A2 for implementing a main function of the ECU-B. In the following description and drawings, the ECU-A app A1 and the ECU-B app A2 may be abbreviated as the app A1 and the app A2, respectively.

The HV 2 is for operating the VM 10 and the VM 11 on the microcomputer 3. The microcomputer 3 is an example of a computer, and includes a CPU (not shown), various storage devices, various peripherals, and the like as its hardware. The various peripherals include a communication HW 12 for performing communication. The various storage devices include a register 13. The register 13 is a register to be protected, that is, a register for which a protection setting related to writing can be performed. The VM 10 includes a communication driver 14. The VM 11 includes a communication driver 15. The communication drivers 14 and 15 control the communication HW 12 to perform data communication with other ECUs including the ECU 4 via the bus communication line 5.

In this case, the HV 2 functions as an operation control device configured to perform control for operating each of the multiple VMs 10 and 11 in a time-division manner by an operation time allocated in advance for each operation cycle. That is, in the integrated ECU 1, control is performed by time-division scheduling that allocates a fixed operation time to the multiple VMs 10 and 11. In this case, the integrated ECU 1 is an example of an electronic control unit including the microcomputer 3, the multiple VMs 10 and 11 operating on the microcomputer 3, and the HV 2 functioning as an operation control device. In the present specification, an operating VM among the multiple VMs 10 and 11 may be referred to as an operating machine.

The HV 2, the VM 10, and the VM 11 are all implemented by the CPU included in the microcomputer 3 executing a computer program stored in a non-transitory tangible storage medium and executing a process corresponding to the computer program, that is, implemented by software. A program executed by the HV 2 among the above-described computer programs corresponds to an operation control program.

The HV 2 includes two functional blocks, a first processing unit 21 and a second processing unit 22. The first processing unit 21 is capable of executing a switching process of switching the operating machine. Each process executed by the first processing unit 21 corresponds to a first process. The second processing unit 22 is capable of executing a prohibition process of prohibiting execution of the switching process and a permission process of permitting execution of the switching process. Each process executed by the second processing unit 22 corresponds to a second process. The term of “processing unit” may be also referred to as a “processor”.

In this case, the operating machine transmits a prohibition request when starting a specific process, which is a process that must be continuously executed, that is, an uninterruptible process or an atomic process, and transmits a permission request when completing the specific process. In the present specification, “a process that has to be continuously executed” includes not only a process that is not established and fails when it is not continuously executed, but also a process that does not yield a processing result of a level desired by a user when it is not continuously executed, that is, a process that is desirable to be continuously executed. The specific process may be also referred to as a process requiring continuous execution.

When receiving the prohibition request, the second processing unit 22 executes a determination process of determining whether a remaining time, which is a time from the reception time to a time when the operation time elapses, is equal to or longer than a predetermined set time. As a result of the determination process, the second processing unit 22 executes the prohibition process when the remaining time is equal to or longer than the set time, and does not execute the prohibition process when the remaining time is less than the set time. When receiving the permission request, the second processing unit 22 executes the permission process. The operating machine executes the specific process during a prohibition period, which is a period during which the prohibition process is executed.

The first processing unit 21 is capable of extending the operation time by a predetermined margin time during the prohibition period. When the extension is performed by the first processing unit 21, the second processing unit 22 executes the determination process with a time from when the prohibition request is received to when an extended operation time elapses as the remaining time. In the present embodiment, an available time that can be used as the margin time is set for each operation cycle. The first processing unit 21 extends the operation time so as to consume a required margin time from the available time. That is, the margin time is allocated from the available time and used.

In a case where there is a surplus in the available time when an operation of an operating machine operating last in the operation cycle is started, the first processing unit 21 allocates at least a part of the surplus to the operation time of the operating machine operating last. In a case where the specific process is not completed at a time when the operation time elapses in the prohibition period, the first processing unit 21 determines that an abnormality has occurred and executes one or both of the switching process and a notification process of notifying an outside of the abnormality. In a case where the specific process is not completed at a time when the operation time elapses in the prohibition period, the first processing unit 21 determines that an abnormality has occurred, and executes the notification process of notifying the outside of the abnormality when receiving the permission request in a subsequent operation cycle.

When the prohibition process is not executed after the operating machine transmits the prohibition request, the first processing unit 21 causes the operating machine to repeatedly execute transmission of the prohibition request until the prohibition process is executed. When the prohibition process is not executed after the operating machine transmits the prohibition request, the first processing unit 21 sets the operating machine to a standby state or sets the operating machine to a state where another process different from the specific process is executable, during a period until the switching process is executed. The first processing unit 21 executes the switching process before the operation time allocated to the operating machine elapses, when the prohibition process is not executed after the operating machine transmits the prohibition request.

The set time can be set by a first setting method or a second setting method below. In the first setting method, the set time is set in advance for each of the multiple virtual machines. In this case, the set time can be set based on a time required for a specific process that may be executed by a virtual machine that is a target of the setting. When there is one specific process that may be executed by the virtual machine, the set time can be set to a time corresponding to the time required for the specific process. The time corresponding to the time required for the specific process includes not only the same time as the time required for the specific process, but also a time providing a predetermined margin with respect to the time.

Further, when there are multiple specific processes that may be executed by the virtual machine, the set time can be set to a time corresponding to the longest time among times required for each of the multiple specific processes. The longest time among the times required for each of the multiple specific processes includes not only the same time as the longest time among the times required for each of the multiple specific processes, but also a time providing a predetermined margin with respect to the time.

In the second setting method, when receiving the prohibition request, the second processing unit 22 sets the set time based on the time required for the specific process started by the operating machine that has transmitted the prohibition request. The set time can be set to a time corresponding to the time required for the specific process started by the operating machine that has transmitted the prohibition request. The time corresponding to the time required for the specific process includes not only the same time as the time required for the specific process, but also a time providing a predetermined margin with respect to the time.

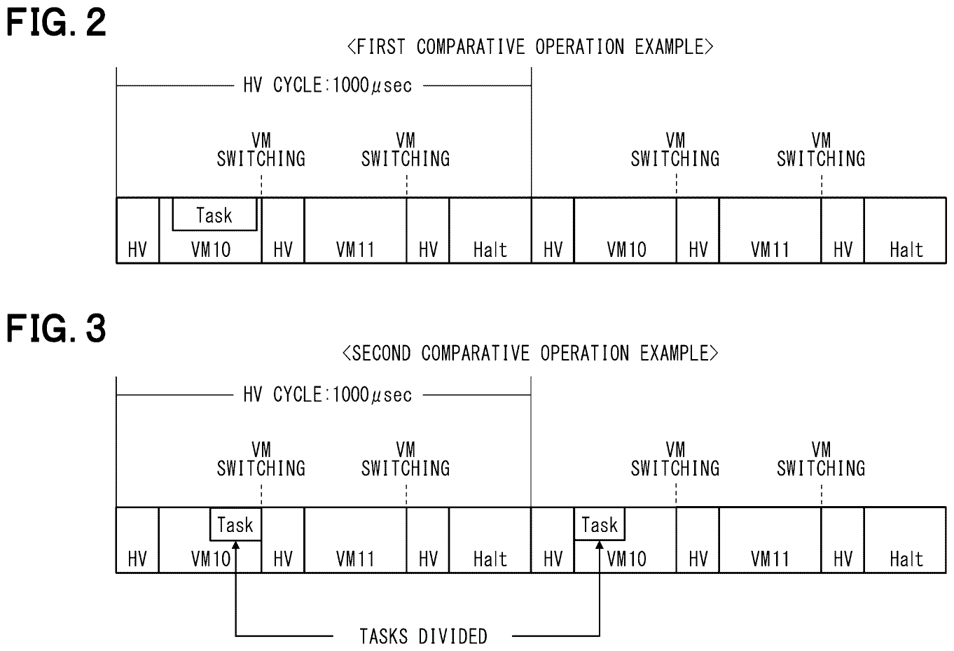

Next, an operation of the above configuration will be described with reference to FIGS. 2 to 21.

In the following description, each term may be expressed otherwise as follows.
Specific process->Task
Starting Switching Process->Vm Switching
Operation cycle->HV cycle
Available time->Total margin time

In this case, it is assumed that the HV cycle is 1000 μs and the total margin time is 50 μs. In FIGS. 2 to 17 and the like, a period during which the operating machine is the VM 10 is expressed as “VM10”, a period during which the operating machine is the VM 11 is expressed as “VM11”. A period during which the first processing unit 21 is executing the switching process is expressed as “HV”. A period during which the operating machine is executing the task is expressed as “Task”. A period during which the microcomputer 3 transitions to a mode for reducing power consumption is expressed as “Halt”. A period during which the prohibition process is executed is expressed as “disable”.

In the following description, for comparison with the present embodiment, in addition to a description of an operation example according to the present embodiment, a comparative operation example, which is an operation example according to a comparative example corresponding to a conventional technology, is also described. Note that in the comparative example, the second processing unit 22 is omitted from the present embodiment, and processes related to each process executed by the second processing unit 22 are also omitted.

### [1-1] First Comparative Operation Example

A first comparative operation example shown in FIG. 2 assumes a case where the VM 10 starts executing a task in the middle of an operation time, and can complete the task without interruption within the operation time. In this case, the VM 10 starts executing the task at a time when a predetermined time has elapsed from a time when the VM 10 itself is switched to the operating machine. In this case, the task executed by the VM 10 is completed before the operation time ends. Thereafter, at a time when the operation time allocated to the VM 10 elapses, the first processing unit 21 executes the switching process.

### [1-2] Second Comparative Operation Example

A second comparative operation example shown in FIG. 3 assumes a case where the VM 10 starts executing a task in the middle of an operation time, and cannot complete the task within the operation time. In this case, the VM 10 starts executing the task at a time when a predetermined time has elapsed from a time when the VM 10 itself is switched to the operating machine. In this case, the task executed by the VM 10 is not completed even at a time when the operation time allocated to the VM 10 elapses, but at this time, the switching process is executed by the first processing unit 21, and thus the task is interrupted.

The interrupted task is resumed in the next HV cycle. That is, in the next HV cycle, the VM 10 resumes execution of the task from a time when the VM 10 itself is switched to the operating machine. In this case, the task executed by the VM 10 is completed at a time when a predetermined time has elapsed from a time when the VM 10 is switched to the operating machine. As described above, in the comparative example, when the VM switching occurs during the execution of the task, the task is interrupted, and it is conceivable that an expected function does not operate. On the other hand, in the present embodiment, an attempt is made to solve such a difficulty by introducing a function in which the VM switching does not occur during the execution of the task.

### [2-1] First Operation Example

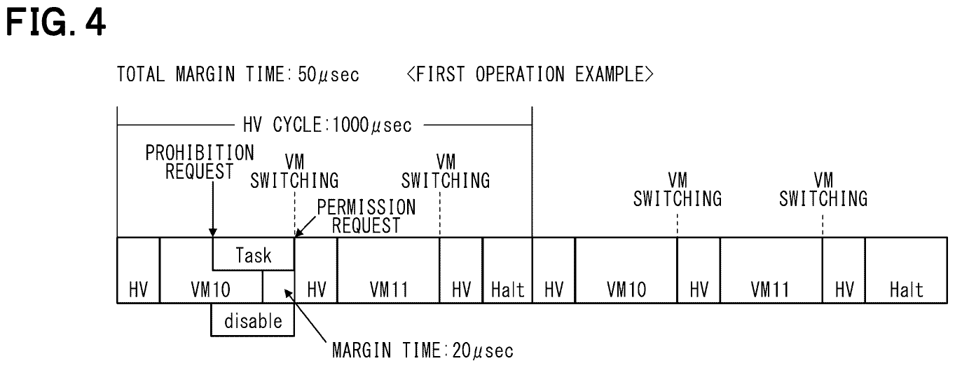

A first operation example shown in FIG. 4 assumes a case where the VM 10 starts executing a task in the middle of an operation time, and can complete the task without interruption. In this case, the VM 10 transmits a prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 50 μs, which is an unused time among the total margin time, to the remaining time is longer than the set time. Then, the HV 2 executes the prohibition process at a time of receiving the prohibition request. In accordance with a start of the prohibition process, the VM 10, which is the operating machine, starts executing the task. In this case, the task is not completed when the initial operation time allocated to the VM 10 elapses. Therefore, the first processing unit 21 extends the operation time until the task being executed by the VM 10 is completed. In this case, 20 μs is consumed from the total margin time to extend the operation time.

According to such a first operation example, the operation time of the VM 10 is extended by 20 μs, so that the VM 10 can continuously complete a task that is an uninterruptible process. The VM 10 transmits a permission request when completing the task. At a time of receiving the permission request, the HV 2 ends the prohibition process and executes the permission process. As a result, the first processing unit 21 executes the switching process. In this manner, even when the operation time is extended, a real-time property can be ensured by performing the VM switching immediately after the task is completed.

### [2-2] Second Operation Example

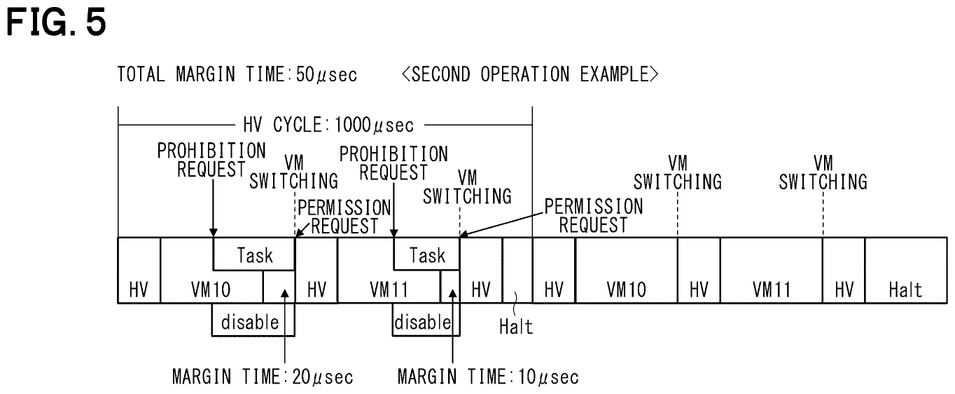

A second operation example shown in FIG. 5 assumes a case where the VMs 10 and 11 start executing a task in the middle of an operation time, and can complete the task without interruption. In this case, an operation of the VM 10 in the operation time is the same as that of the first operation example. In this case, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process.

In this case, it is assumed that a time obtained by adding 30 μs, which is an unused time among the total margin time, to the remaining time is longer than the set time. Then, the HV 2 executes the prohibition process at a time of receiving the prohibition request. In accordance with a start of the prohibition process, the VM 11, which is the operating machine, starts executing the task. In this case, the task is not completed at a time when the initial operation time allocated to the VM 11 elapses.

Therefore, the first processing unit 21 extends the operation time until the task being executed by the VM 11 is completed. In this case, 10 μs is consumed from the total margin time to extend the operation time. According to such a second operation example, the operation time of the VM 11 is extended by 10 μs, so that the VM 11 can continuously complete a task that is an uninterruptible process. The VM 11 transmits a permission request when completing the task. At a time of receiving the permission request, the HV 2 ends the prohibition process and executes the permission process. As a result, the first processing unit 21 executes the switching process.

In this manner, even when the operation time is extended, a real-time property can be ensured by performing the VM switching immediately after the task is completed. As can be seen from the second operation example, according to the configuration of the present embodiment, as long as there is a time not yet used in the total margin time, the margin time can be allocated by an amount requested from the multiple VMs. By setting the margin time for the entire HV cycle as in the present embodiment, a requested margin time can be adaptively distributed for each VM.

### [2-3] Third Operation Example

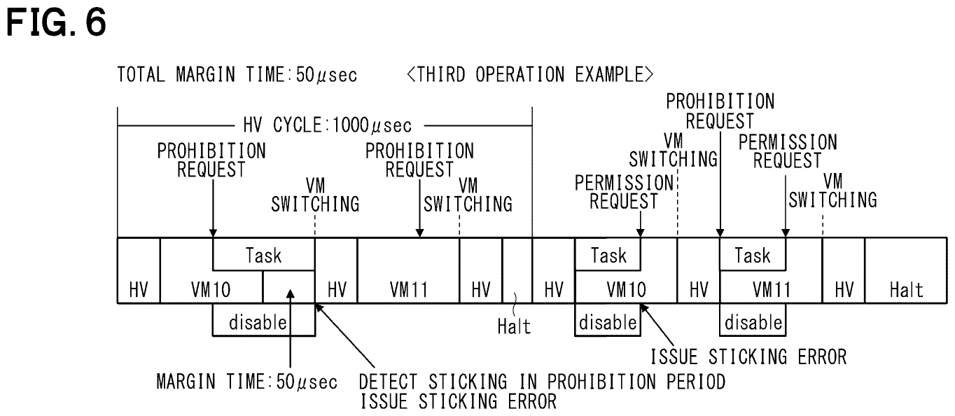

A third operation example shown in FIG. 6 assumes a case where the VM 10 starts executing a task in the middle of an operation time, and the task is not completed. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 50 μs, which is an unused time among the total margin time, to the remaining time is longer than the set time. Then, the HV 2 executes the prohibition process at a time of receiving the prohibition request. In accordance with a start of the prohibition process, the VM 10, which is the operating machine, starts executing the task. In this case, the task is not completed at a time when the initial operation time allocated to the VM 10 elapses. Therefore, the first processing unit 21 extends the operation time until the task being executed by the VM 10 is completed.

However, in this case, it is assumed that the task is not completed even when 50 μs, which is the entire total margin time, is consumed and the operation time is extended due to some reason such as an abnormality or a failure. Then, the first processing unit 21 determines that an abnormality has occurred, and executes the notification process. The notification process issues a sticking error indicating that a state in which the VM switching is prohibited, that is, the prohibition period is stuck, has been detected. Also, at this time, the first processing unit 21 executes the switching process with the VM switching prohibited in this manner.

In this case, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process. In this case, it is assumed that the remaining time is shorter than the set time because the VM 10 has used the entire total margin time. Therefore, the HV 2 does not execute the prohibition process. As a result, the VM 11 cannot start executing the task in this HV cycle.

In this way, when the prohibition process is not executed after the VM 11, which is the operating machine, transmits the prohibition request, the first processing unit 21 places the VM 11, which is the operating machine, in a standby state during a period until the switching process is executed. In this case, the first processing unit 21 can also set the VM 11, which is the operating machine, in a state where another process different from the task is executable, during a period until the switching process is executed. Thereafter, at a time when the operation time allocated to the VM 11 elapses, the first processing unit 21 executes the switching process.

In the next HV cycle, the VM 10 resumes execution of the task from a time when the VM 10 itself is switched to the operating machine. In this case, the task executed by the VM 10 is completed at a time when a predetermined time has elapsed from a time when the VM 10 is switched to the operating machine. The VM 10 transmits a permission request when completing the task. At a time of receiving the permission request, the HV 2 ends the prohibition process and executes the permission process. Also, at this time, the HV 2 executes the notification process, whereby a sticking error is issued. Thereby, a determination on rebooting a VM or interrupting a process can be made in the integrated ECU 1.

Thereafter, at a time when the operation time allocated to the VM 10 elapses, the first processing unit 21 executes the switching process. The VM 11 transmits the prohibition request to the HV 2 at a time when the VM 11 itself is switched to the operating machine. When receiving the prohibition request transmitted from the VM 11, the HV 2 executes the determination process. In this case, it is assumed that a time obtained by adding 50 μs, which is an unused time among the total margin time, to the remaining time is longer than the set time. Then, the HV 2 executes the prohibition process at a time of receiving the prohibition request. In accordance with a start of the prohibition process, the VM 11, which is the operating machine, starts executing the task.

In this case, the task executed by the VM 11 is completed at a time when a predetermined time has elapsed from a time when the VM 11 is switched to the operating machine. The VM 11 transmits a permission request when completing the task. At a time of receiving the permission request, the HV 2 ends the prohibition process and executes the permission process. Thereafter, at a time when the operation time allocated to the VM 11 elapses, the first processing unit 21 executes the switching process. As can be seen from the third operation example, according to the configuration of the present embodiment, by operating a VM with a higher priority sequentially from the head of an HV cycle, the margin time can be preferentially allocated to the VM with a higher priority.

### [2-4] Fourth Operation Example

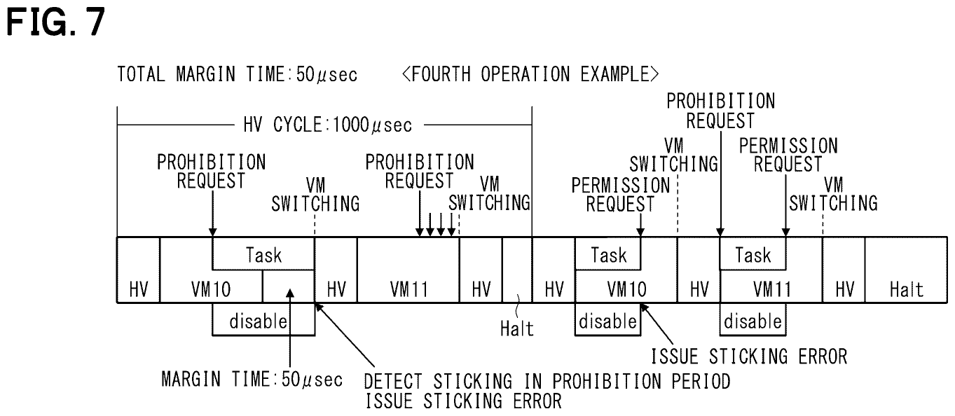

A fourth operation example shown in FIG. 7 differs from the third operation example in the following points. That is, in the fourth operation example, when the prohibition process is not executed after the VM 11, which is the operating machine, transmits the prohibition request, the first processing unit 21 causes the VM 11, which is the operating machine, to repeatedly execute transmission of the prohibition request until the prohibition process is executed. In FIG. 7, repeatedly transmitted prohibition requests are represented by simple arrows.

### [2-5] Fifth Operation Example

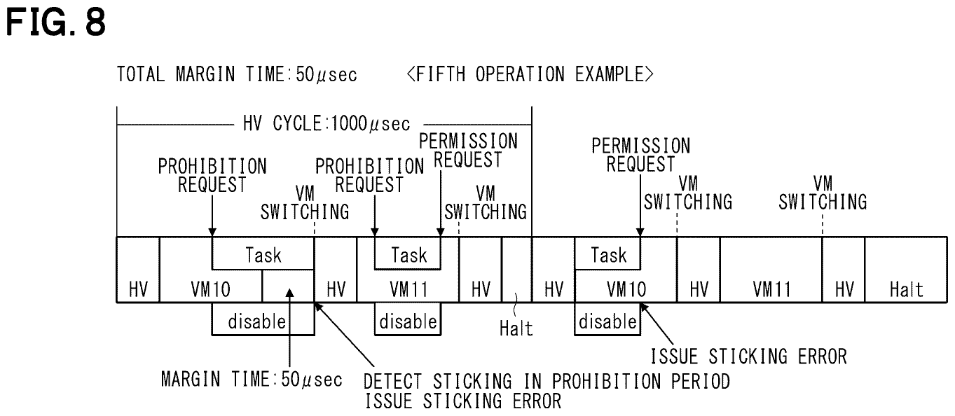

A fifth operation example shown in FIG. 8 differs from the third operation example in an operation related to the VM 11. That is, in the fifth operation example, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process. In this case, the operation time of the VM 11 cannot be extended because the entire total margin time is used by the VM 10. However, it is assumed that the remaining time from that time to a time when an unextended operation time elapses is shorter than the set time.

Then, the HV 2 executes the prohibition process at a time of receiving the prohibition request. In accordance with a start of the prohibition process, the VM 11, which is the operating machine, starts executing the task. In this case, the task executed by the VM 11 is completed at a time when a predetermined time has elapsed from a start time of the prohibition process. The VM 11 transmits a permission request when completing the task. At a time of receiving the permission request, the HV 2 ends the prohibition process and executes the permission process. Thereafter, at a time when the operation time allocated to the VM 11 elapses, the first processing unit 21 executes the switching process.

As can be seen from the fifth operation example, according to the configuration of the present embodiment, even in a case where the entire total margin time is used and there is no margin time, when a task completion time can be secured, the prohibition process is executed. As a result, the task can be continuously completed during the operation time.

### [2-6] Sixth Operation Example

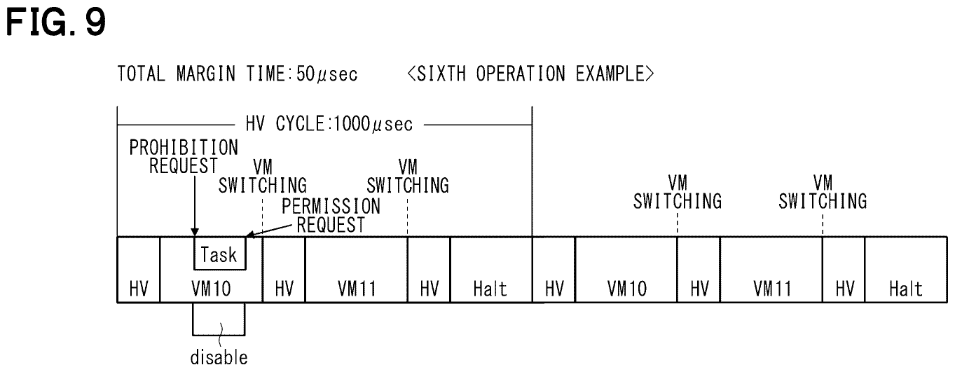

A sixth operation example shown in FIG. 9 assumes a case where the VM 10 starts executing a task in the middle of an operation time, and can complete the task without interruption and without extending the operation time. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 50 μs, which is an unused time among the total margin time, to the remaining time is longer than the set time. Then, the HV 2 executes the prohibition process at a time of receiving the prohibition request. In accordance with a start of the prohibition process, the VM 10, which is the operating machine, starts executing the task. In this case, the task executed by the VM 10 is completed at a time when a predetermined time has elapsed from the start time of the prohibition process. The VM 10 transmits a permission request when completing the task. At a time of receiving the permission request, the HV 2 ends the prohibition process and executes the permission process. Thereafter, at a time when the operation time allocated to the VM 10 elapses, the first processing unit 21 performs the switching process.

### [2-7] Seventh Operation Example

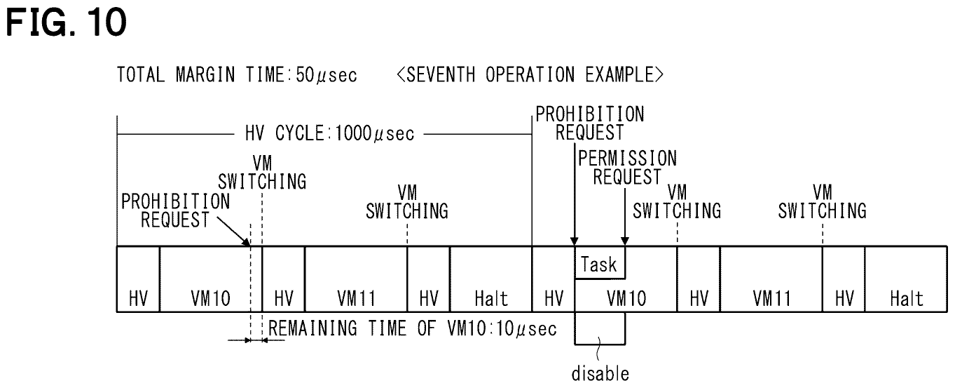

A seventh operation example shown in FIG. 10 assumes a case where the VM 10 attempts to start executing a task in the middle of an operation time, but cannot execute the task within the operation time in the HV cycle, and executes the task within an operation time in the next HV cycle. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 50 μs, which is an unused time among the total margin time, to the remaining time is shorter than the set time. Therefore, the HV 2 does not execute the prohibition process, and as a result, the VM 10 cannot start executing the task in this HV cycle. Then, in the next HV cycle, the VM 10 transmits the prohibition request to the HV 2 at a time when the VM 10 itself is switched to the operating machine. When receiving the prohibition request transmitted from the VM 10, the HV 2 executes the determination process. In this case, it is assumed that a time obtained by adding 50 μs, which is an unused time among the total margin time, to the remaining time is longer than the set time.

Then, the HV 2 executes the prohibition process at a time of receiving the prohibition request. In accordance with a start of the prohibition process, the VM 10, which is the operating machine, starts executing the task. In this case, the task executed by the VM 10 is completed at a time when a predetermined time has elapsed from a time when the VM 10 is switched to the operating machine. The VM 10 transmits a permission request when completing the task. At a time of receiving the permission request, the HV 2 ends the prohibition process and executes the permission process. Thereafter, at a time when the operation time allocated to the VM 10 elapses, the first processing unit 21 executes the switching process.

As can be seen from the seventh operation example, according to the configuration of the present embodiment, when the prohibition request is transmitted from an operating machine to the HV 2, if the HV 2 determines that a remaining time is less than a set time, a prohibition process is not executed, and therefore, a task that is not expected to be completed within an operation time in the HV cycle can be executed within an operation time in the next HV cycle. Thus, according to the configuration of the present embodiment, since a time until VM switching is known in advance, a real-time property can be ensured without unnecessarily extending an operation time and without affecting other VMs.

### [2-8] Eighth Operation Example

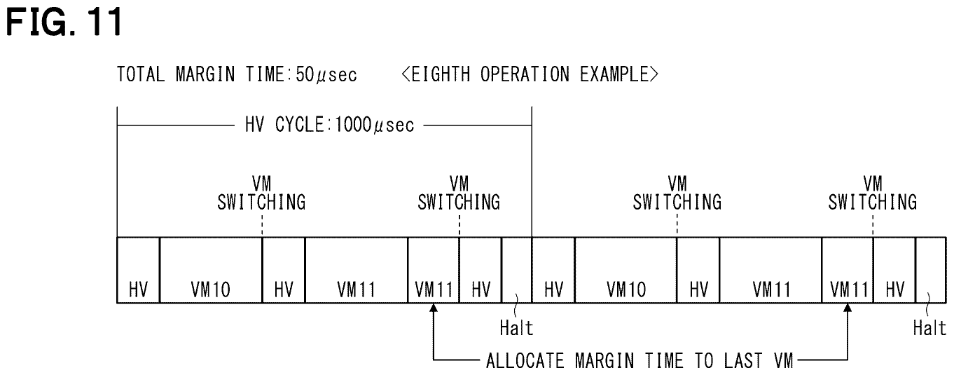

An eighth operation example shown in FIG. 11 assumes a case where there is a surplus in the total margin time when an operation of an operating machine operating last in an HV cycle is started. In this case, since neither the VM 10 nor the VM 11 executed a task, it is assumed that the total margin time is not consumed and 50 μs remains as it is when the operation of the VM 11 is started. The first processing unit 21 allocates at least a part of such a surplus of the total margin time to an operation time of the VM 11, which is the operating machine operating last. Thereby, it is possible to effectively utilize resources of the microcomputer 3 and eliminate a time during which no processing is operated.

### [2-9] Ninth Operation Example

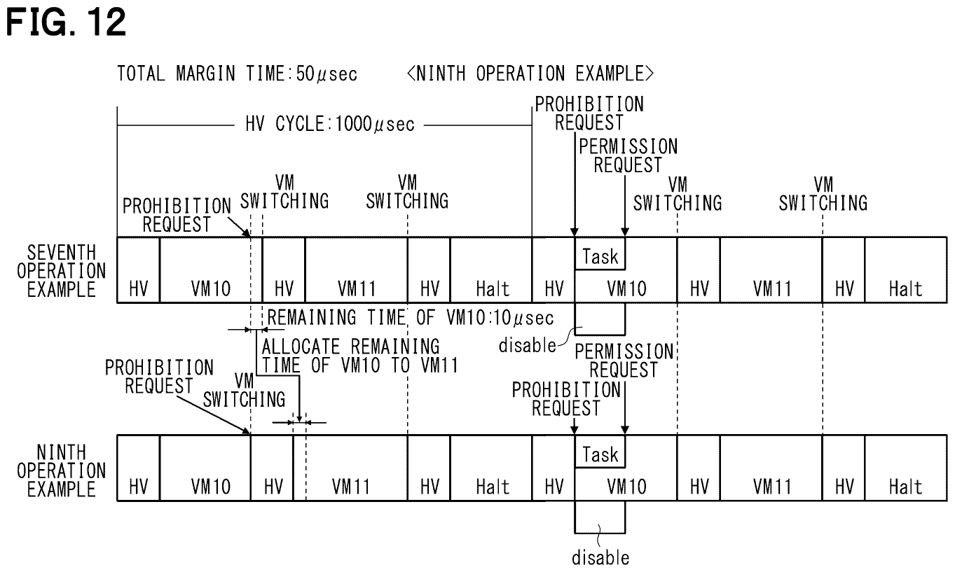

A ninth operation example shown in FIG. 12 differs from the seventh operation example in the following points. For comparison among the respective operation examples, a diagram similar to FIG. 10 used for describing the seventh operation example is also shown in an upper part of FIG. 12. That is, as shown in a lower part of FIG. 12, in the ninth operation example, when the prohibition process is not executed after the VM 10, which is the operating machine, transmits the prohibition request, the first processing unit 21 executes the switching process before the operation time allocated to the VM 10, which is the operating machine, elapses.

According to such a ninth operation example, when the prohibition process is not executed after the VM 10, which is the operating machine, transmits the prohibition request, the remaining operation time allocated to the VM 10 is distributed to another VM 11. Thereby, when there is no other operable process in the VM 10, the VM 10 does not consume a useless time, and the time can be allocated as an operation time of the other VM 11. As a result, it is possible to effectively utilize resources of the microcomputer 3.

### [1-3] Third Comparative Operation Example

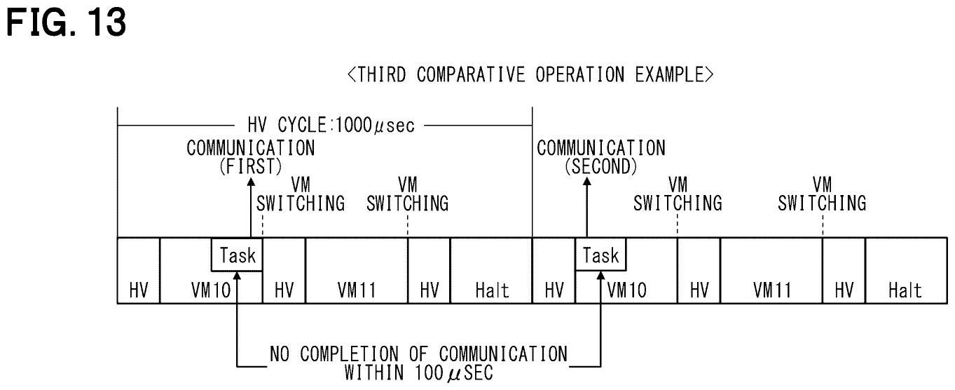

A third comparative operation example shown in FIG. 13 differs from the second comparative operation example in that a specific content of a task is defined. In this case, communication performed between the integrated ECU 1 and the ECU 4 is divided into a plurality of parts, and it is necessary to transmit or receive all communication data from the VM 10 to the ECU 4 within a predetermined time, for example, 100 μs. The VM 10 performs the above-described communication as a task. It is assumed that the communication performed by the VM 10 is divided into two times.

In this case, the VM 10 executes transmission or reception of first communication data to or from the ECU 4 at a time when a predetermined time has elapsed from a time when the VM 10 itself is switched to the operating machine. Thereafter, since an operation time allocated to the VM 10 ends at a time before the VM 10 executes transmission or reception of second communication data to or from the ECU 4, the switching process is executed by the first processing unit 21. That is, at this time, the communication process is interrupted. Then, in the next HV cycle, the VM 10 executes the transmission or reception of the second communication data to or from the ECU 4 at a time when the VM 10 itself is switched to the operating machine.

In this way, in the third comparative operation example, a VM switching occurs after transmission or reception of first communication data, and transmission or reception of second communication data is performed in the next HV cycle, so that all the communication data is not transmitted or received within 100 μs. However, in this case, since the communication process is normally completed from the viewpoint of the VM 10, retransmission or re-reception of the communication data is not performed, and there is a possibility that the communication between the integrated ECU 1 and the ECU 4 remains failed.

### [2-10] Tenth Operation Example

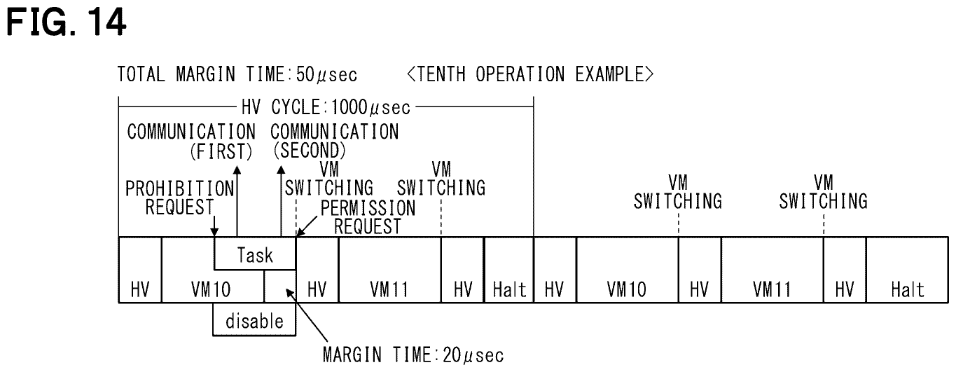

A tenth operation example shown in FIG. 14 differs from the first operation example in that a specific content of a task is defined. The specific content of the task is the same as that of the third comparative operation example. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 50 μs, which is an unused time among the total margin time, to the remaining time is longer than the set time. Then, the HV 2 executes the prohibition process at a time of receiving the prohibition request. In accordance with a start of the prohibition process, the VM 10, which is the operating machine, executes transmission or reception of first communication data to or from the ECU 4. Also in this case, similarly to the third comparative operation example, the initial operation time allocated to the VM 10 ends before the VM 10 executes transmission or reception of second communication data to or from the ECU 4. However, in this case, the first processing unit 21 extends the operation time until the task being executed by the VM 10 is completed.

Therefore, the VM 10 can execute transmission or reception of second communication data to or from the ECU 4 continuously after executing transmission or reception of first communication data to or from the ECU 4 in the HV cycle. Thus, according to the tenth operation example, all communication data can be transmitted or received within 100 μs. That is, according to the tenth operation example, the communication process can be continuously completed without being interrupted by a VM switching.

### [1-4] Fourth Comparative Operation Example

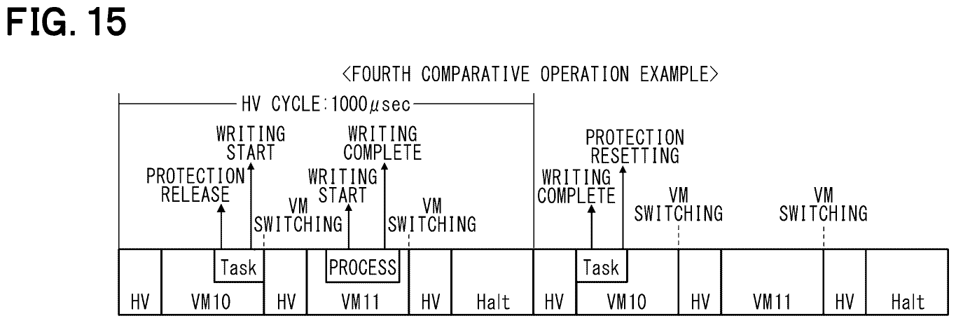

A fourth comparative operation example shown in FIG. 15 assumes write control to the register 13 as a specific content of a task. The write control to the register 13 includes three processes: a “protection release” process for releasing a protection setting of the register 13, a “writing” process for writing to the register 13, and a “protection resetting” process for resetting the protection setting of the register 13.

In this case, the VM 10 starts writing control at a time when a predetermined time has elapsed from a time when the VM 10 itself is switched to the operating machine. That is, the VM 10 first executes a protection release process, and then starts a writing process. Thereafter, since an operation time allocated to the VM 10 ends at a time before the VM 10 completes the writing process, the switching process is executed by the first processing unit 21. That is, in this case, a VM switching occurs during the writing process, thereby interrupting the write control.

At this time, the protection setting of the register 13 remains released. Therefore, there is a possibility that the VM 11 switched to the operating machine thereafter performs writing to the register 13. In that case, the content of the register 13 is rewritten by another VM 11. Thereafter, in the next HV cycle, the VM 10 resumes the writing process at a time when the VM 10 itself is switched to the operating machine, but since the content of the register 13 has been rewritten by the VM 11 in the previous HV cycle, there is a possibility that an error occurs in the setting of the register 13.

### [1-5] Fifth Comparative Operation Example

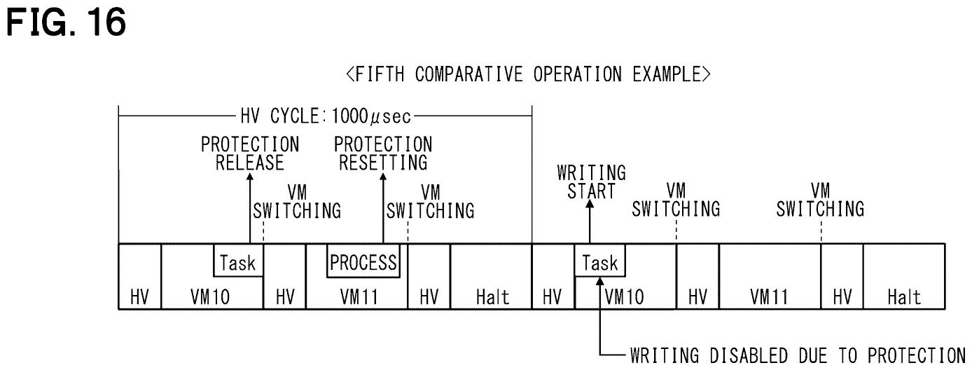

A fifth comparative operation example shown in FIG. 16 differs from the fourth comparative operation example in a timing at which a VM switching occurs. That is, in the fifth comparative operation example, since an operation time allocated to the VM 10 ends at a time after the protection release process is executed and before the writing process is started, a switching process is performed by the first processing unit 21. That is, in this case, a VM switching occurs after the execution of the protection release process, thereby interrupting the write control.

Then, there is a possibility that the VM 11 switched to the operating machine thereafter performs write control to the register 13, and in that case, a protection resetting is performed on the register 13 by another VM 11. Thereafter, in the next HV cycle, the VM 10 attempts to start the writing process at a time when the VM 10 itself is switched to the operating machine, but since protection of the register 13 is set, writing cannot be performed. As a result, the write control of the register 13 by the VM 10 cannot be normally completed.

### [2-11] Eleventh Operation Example

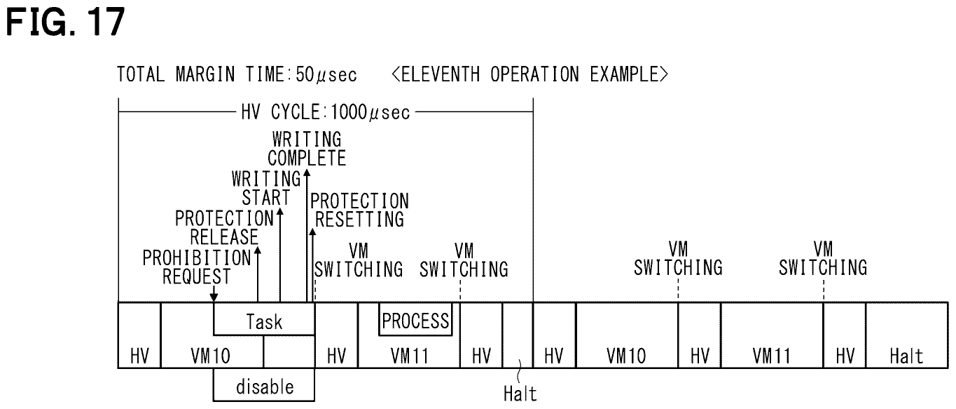

An eleventh operation example shown in FIG. 17 assumes write control to the register 13 as a specific content of a task, similarly to the fourth comparative operation example and the fifth comparative operation example. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process. In this case, it is assumed that a time obtained by adding 50 μs, which is the unused time among the total margin time, to the remaining time is longer than the set time. Then, the HV 2 executes the prohibition process at a time of receiving the prohibition request.

In accordance with a start of the prohibition process, the VM 10, which is the operating machine, starts write control. That is, the VM 10 first executes a protection release process, and then starts a writing process. Thereafter, the initial operation time allocated to the VM 10 ends at a time before the VM 10 completes the writing process. However, in this case, the first processing unit 21 extends the operation time until the task being executed by the VM 10 is completed.

Therefore, the VM 10 can continuously execute all processes in the write control in the HV cycle. Thus, according to the configuration of the present embodiment, a series of processes in the write control can be normally completed without causing the difficulties that occur in the fourth comparative operation example and the fifth comparative operation example. Note that also in the eleventh operation example, when a result that a time obtained by adding a margin time to a remaining time is shorter than a set time is obtained in the determination process, write control is executed in an operation time in the next HV cycle, similarly to the seventh operation example.

### [3] Allocation of Overall Margin Time

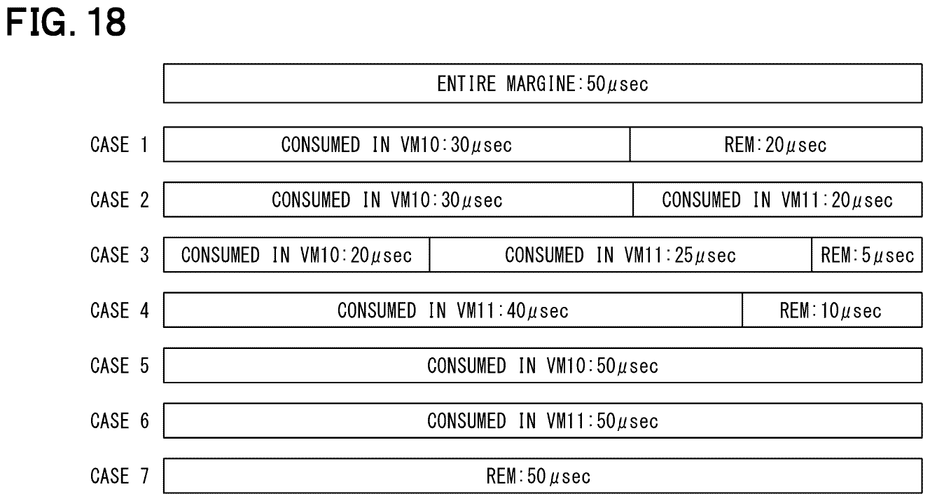

As shown in FIG. 18, there are various cases conceivable as to how the total margin time set for each HV cycle is allocated to and consumed by each of the VMs 10 and 11. In Case 1, 30 μs is consumed as the margin time in the VM 10, and the remaining 20 μs is not consumed and is left over. In Case 2, 30 μs is consumed as the margin time in the VM 10, and 20 μs is consumed as the margin time in the VM 11. That is, Case 2 is a case where the VM 10 and the VM 11 share the total margin time and there is no surplus in the total margin time. In the drawings, the term of “remaining” may be also referred to as “REM”.

In Case 3, 20 μs is consumed as the margin time in the VM 10, and 25 μs is consumed as the margin time in the VM 11. That is, Case 3 is a case where the VM 10 and the VM 11 share the total margin time and a surplus of 5 μs occurs in the total margin time. In Case 4, 40 μs is consumed as the margin time in the VM 10, and the remaining 10 μs is not consumed and is left over.

In Case 5, 50 μs is consumed as the margin time in the VM 10, and there is no surplus in the total margin time. In Case 6, 50 μs is consumed as the margin time in the VM 11, and there is no surplus in the total margin time. In Case 7, no margin time is consumed in either the VM 10 or the VM 11, and a surplus of 50 μs, which is the entire total margin time, occurs. The number of such cases regarding the allocation of the total margin time further increases depending on the number of VMs mounted on the integrated ECU 1.

### [4-1] Specific Contents of Each Process Executed When Prohibition Request is Received

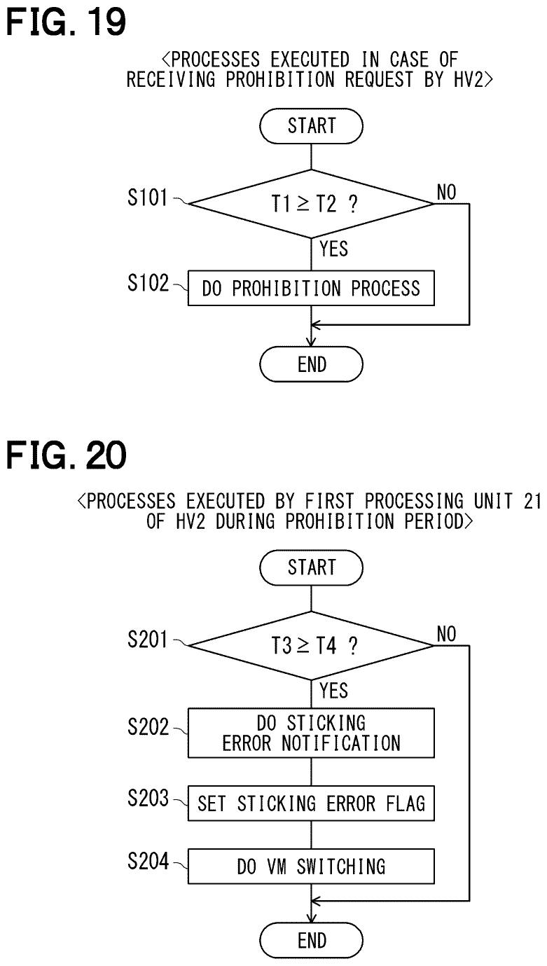

Specifically, each process executed by the HV 2 when receiving the prohibition request can have a content as shown in FIG. 19. The second processing unit 22 executes a process having a content as shown in FIG. 19 every time it receives the prohibition request. In S101, it is determined whether a time T1 obtained by adding an available margin time to a time from when the prohibition request is received to when an operation time elapses is equal to or longer than a time T2 that is a set time.

Here, when the time T1 is equal to or longer than the time T2, the process proceeds to “YES” in S101, and proceeds to S102. In S102, the prohibition process is executed. After the execution of S102, the present process ends. On the other hand, when the time T1 is shorter than the time T2, the process proceeds to “NO” in S101, and the present process ends without executing the prohibition process of S102. According to such a process, since a time until VM switching is known in advance, a real-time property can be ensured without unnecessarily extending an operation time and without affecting other VMs.

### [4-2] Specific Contents of Each Process Executed in Prohibition Period

Specifically, each process executed by the first processing unit 21 of the HV 2 in a prohibition period can have a content as shown in FIG. 20. The first processing unit 21 executes a process having a content as shown in FIG. 20 every predetermined cycle during a prohibition period. In S201, it is determined whether a time T3 that is a margin time consumed during the prohibition period is equal to or longer than a time T4 that is a set margin time.

Here, when the time T3 is equal to or longer than the time T4, the process proceeds to “YES” in S201, and proceeds to S202. In S202, a sticking error is issued and notified. Step S202 corresponds to a notification process. After the execution of S202, the process proceeds to S203, and a sticking error flag is set. After the execution of S203, the process proceeds to S204, and a switching process is performed. After the execution of S204, the present process ends. On the other hand, when the time T3 is shorter than the time T4, the process proceeds to “NO” in S201, and the present process ends without executing the processes of S202 to S204, that is, processes such as the notification process and the switching process.

According to such a process, when the consumed margin time becomes equal to the set margin time, the sticking error is issued and the sticking error flag is set, and VM switching is performed thereafter, so that a real-time property in the entire HV 2 is guaranteed. In addition, according to the above process, by issuing a sticking error, it can be used as determination material for causing a VM to execute a process again or rebooting a VM.

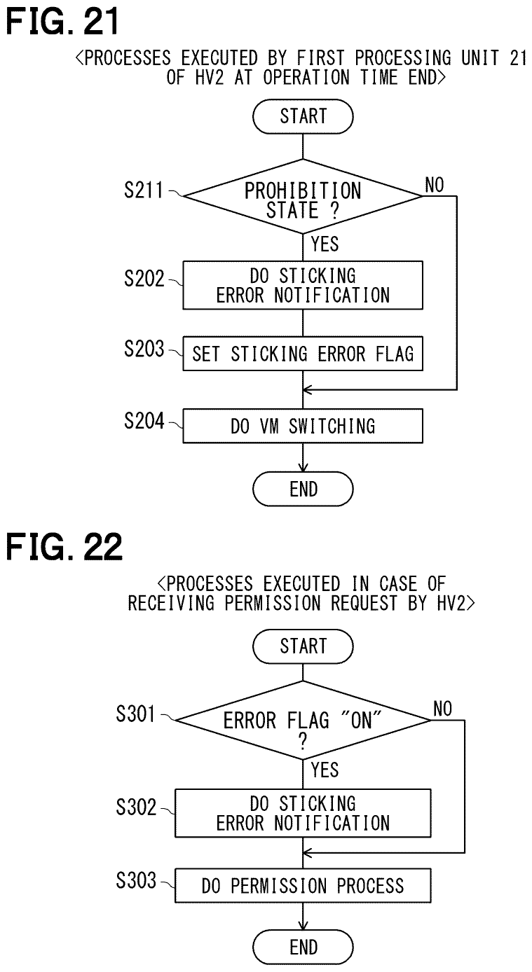

Note that the first processing unit 21 can execute each process according to a modification having a content as shown in FIG. 21 instead of each process according to the present embodiment shown in FIG. 20. Each process according to the modification shown in FIG. 21 is executed when an operation time obtained by adding a set margin time to an initial operation time allocated to a VM, that is, an operation time including a margin time, ends, and differs from each process according to the present embodiment shown in FIG. 20 in that S211 is provided instead of S201. In S211, it is determined whether there is a prohibition state in which execution of the switching process is prohibited.

Here, when there is the prohibition state, the process proceeds to “YES” in S211, and proceeds to S202. On the other hand, when there is no prohibition state, the process proceeds to “NO” in S211, and proceeds to S204, and the present process ends after the switching process is executed. According to such a modification, in a case where the operation time added with the set margin time ends, when the prohibition state has occurred in which the execution of the switching process is prohibited, the sticking error flag is set, that is, VM sticking is determined.

### [4-3] Specific Contents of Each Process Executed When Permission Request is Received

Specifically, each process executed by the HV 2 when receiving the permission request can have a content as shown in FIG. 22. The second processing unit 22 executes a process having a content as shown in FIG. 22 every time it receives a permission request. In S301, it is determined whether the sticking error flag is set, in other words, whether the sticking error flag is raised. Note that in FIG. 22, the fact that the sticking error flag is raised is referred to as error flag “ON”. Here, when the sticking error flag is raised, the process proceeds to “YES” in S301, and proceeds to S302. In S302, the sticking error is issued and notified.

S302 corresponds to the notification process. After the execution of S302, the process proceeds to S303, and the permission process is executed. After the execution of S303, the present process ends. On the other hand, when the sticking error flag is not raised, the process proceeds to “NO” in S301, the process proceeds to S303 without executing the process of S302, that is, the notification process, and the permission process is executed. According to such a process, by issuing a sticking error also when a permission process is executed, it can be clarified that the execution of the specific process ends after the occurrence of sticking of the prohibition period.

According to the present embodiment described above, the following effects can be obtained. The HV 2 included in the integrated ECU 1 of the present embodiment performs control for operating each of the multiple VMs 10 and 11 in a time-division manner by an operation time allocated in advance for each HV cycle. The HV 2 includes: a first processing unit 21 capable of executing the switching process of switching the operating machine; and a second processing unit 22 capable of executing the prohibition process of prohibiting execution of the switching process and the permission process of permitting execution of the switching process. The VMs 10 and 11 transmit the prohibition request when starting the specific process, and transmit the permission request when completing the specific process.

When receiving the prohibition request, the second processing unit 22 executes a determination process of determining whether a remaining time, which is a time from that time to a time when the operation time elapses, is equal to or longer than a predetermined set time. As a result, the second processing unit 22 executes the prohibition process when the remaining time is equal to or longer than the set time, and does not execute the prohibition process when the remaining time is less than the set time. In addition, when receiving the permission request, the second processing unit 22 executes the permission process. The operating machine executes the specific process during the prohibition period, which is a period during which the prohibition process is executed.

According to the above configuration, it is possible to prevent the switching process for switching the operating machine from occurring while the operating machine is executing the specific process. Thereby, consistent operation can be guaranteed until the specific process is completed. Further, according to the above configuration, the second processing unit 22 executes the determination process. Thus, when the remaining time is less than the set time, in other words, when there is an extremely low possibility that the specific process to be started from now can be completed by the time the operation time elapses, the prohibition process is not executed. Accordingly, the specific process is not executed. Thereby, the specific process that is not expected to be completed in the HV cycle can be executed in the next HV cycle. Thus, according to the configuration of the present embodiment, it is possible to obtain the excellent effect of preventing the specific process, which is a process that has to be continuously executed, from being interrupted by the switching process.

In the present embodiment, in the prohibition period in which the execution of the switching process is prohibited, the originally set operation time can be extended by a margin time, and execution of the specific process by the operating machine continues until the extended operation time elapses. Thereby, it is possible to continuously complete the specific process more reliably without interruption. Further, in the present embodiment, when the specific process is not completed by the time the extended operation time elapses, the notification process and a switching process are executed.

Thereby, an extension of an operation time exceeding a set margin time is not performed, a situation in which only a specific VM operates unnecessarily for a long time is prevented from occurring. Adverse effects such as a decrease in operation time of other VMs do not occur, and it is possible to ensure a real-time property. Further, according to the present embodiment, by executing the notification process for notifying the sticking error, rebooting, re-execution of the specific process, or the like can be executed for an operating machine that has not completed the specific process.

In the present embodiment, a total margin time is set for each HV cycle, and the first processing unit 21 extends an operation time so as to consume a required margin time from the total margin time. Thereby, the margin time can be set for the entire HV 2. Therefore, it is possible to simplify the setting. Also, thereby, the margin time requested by each VM can be adaptively distributed in the HV cycle. Furthermore, thereby, by operating the VM with a higher priority sequentially from the head of the HV cycle among multiple VMs, the margin time can be preferentially given to the VM with a relatively high priority.

In a case where an operation of an operating machine operating last in an HV cycle starts, when there is a surplus in the total margin time, the first processing unit 21 allocates at least a part of the surplus to an operation time of the operating machine operating last. Thereby, a useless margin time can be eliminated. When the specific process is not completed at a time when the operation time elapses in the prohibition period, the first processing unit 21 determines that an abnormality has occurred and executes a switching process and a notification process of notifying an outside of the abnormality. Thereby, for example, when the specific process is not completed normally, it is possible to prevent the operation time of another VM from being affected while a prohibition process is continuously executed, so that a real-time property can be ensured, and it is possible to make a determination on rebooting the VM or interrupting the specific process.

In a case where the specific process is not completed at a time when the operation time elapses in the prohibition period, the first processing unit 21 determines that an abnormality has occurred, and executes the notification process of notifying the outside of the abnormality when receiving the permission request in a subsequent HV cycle. Thereby, by notification through the notification process that the operation is continuing with the prohibition period stuck, it is possible to make a determination on rebooting the VM or interrupting the specific process.

The set time can be set in advance for each of the multiple VMs 10 and 11. Thereby, the time during which each VM operates can be uniformly managed. Alternatively, when receiving the prohibition request, the second processing unit 22 can set the set time based on a time required for a specific process started by an operating machine that has transmitted the prohibition request. Thereby, for example, when the specific process cannot be completed normally due to some reason, a time to extend an operation time can be minimized. As a result, a real-time property can be ensured.

When the prohibition process is not executed after the operating machine transmits the prohibition request, the first processing unit 21 can cause the operating machine to repeatedly execute transmission of the prohibition request until the prohibition process is executed. Thereby, the VM itself can complete processing without requesting a time until VM switching from the HV 2. When the prohibition process is not executed after the operating machine transmits the prohibition request, the first processing unit 21 can place the operating machine in a standby state during a period until a switching process is executed. Thereby, the microcomputer 3 can be shifted to sleep or the like to reduce power consumption.

When the prohibition process is not executed after an operating machine transmits the prohibition request, the first processing unit 21 can place the operating machine in a state where another process different from a specific process is executable, during a period until the switching process is executed. Thereby, another process can be executed in a time until VM switching. As a result, resources of the microcomputer 3 can be effectively utilized. The first processing unit 21 executes the switching process before the operation time allocated to the operating machine elapses, when the prohibition process is not executed after the operating machine transmits the prohibition request. Thereby, when there is no executable process other than the specific process in the operating machine, another VM can be operated. As a result, resources of the microcomputer 3 can be effectively utilized.

### Second Embodiment

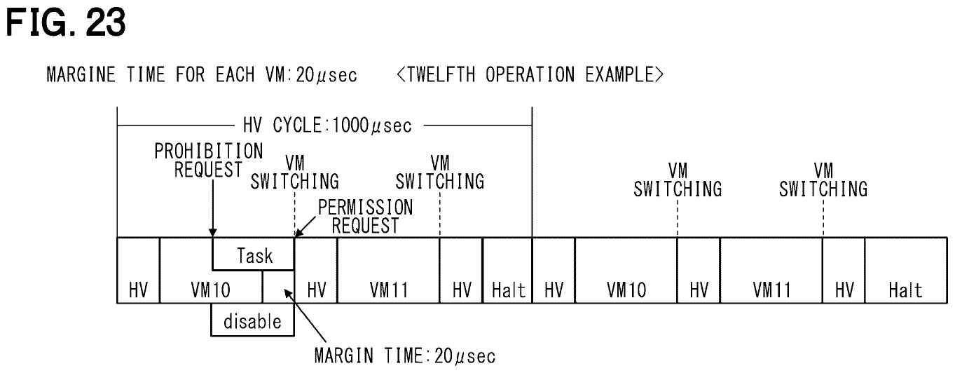

A second embodiment will be described below with reference to FIGS. 23 to 25. In the present embodiment, a change is made to the setting of an available time relative to the first embodiment. In the present embodiment, an available time is set for each of multiple VMs 10 and 11. In addition, the first processing unit 21 extends an operation time so as to consume the required margin time from an available time corresponding to the operating machine. That is, the margin time is allocated and used from the available time corresponding to the operating machine.

Next, an operation of the above configuration will be described. In the following description, the available time may be referred to as a margin time per VM. In this case, it is assumed that the margin time per VM is 20 μs for both the VM 10 and the VM 11.

### [2-12] Twelfth Operation Example

A twelfth operation example shown in FIG. 23 assumes a case where the VM 10 starts executing a task in the middle of the operation time, and can complete the task without interruption. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 20 μs, which is a margin time per VM corresponding to the VM 10, to the remaining time is longer than the set time. Then, the HV 2 executes the prohibition process at a time of receiving the prohibition request. In accordance with a start of the prohibition process, the VM 10, which is the operating machine, starts executing the task. In this case, the task is not completed at a time when the initial operation time allocated to the VM 10 elapses. Therefore, the first processing unit 21 extends the operation time until the task being executed by the VM 10 is completed. In this case, 20 μs, which is the entire margin time per VM, is consumed to extend the operation time.

According to such a twelfth operation example, the VM 10 can extend its operation time up to the margin time per VM, and can continuously complete a task that is an uninterruptible process. The VM 10 transmits the permission request when completing the task. At a time of receiving the permission request, the HV 2 ends the prohibition process and executes the permission process. Thereby, the first processing unit 21 executes the switching process. In this manner, even when the operation time is extended, a real-time property can be ensured by performing the VM switching immediately after the task is completed.

### [2-13] Thirteenth Operation Example

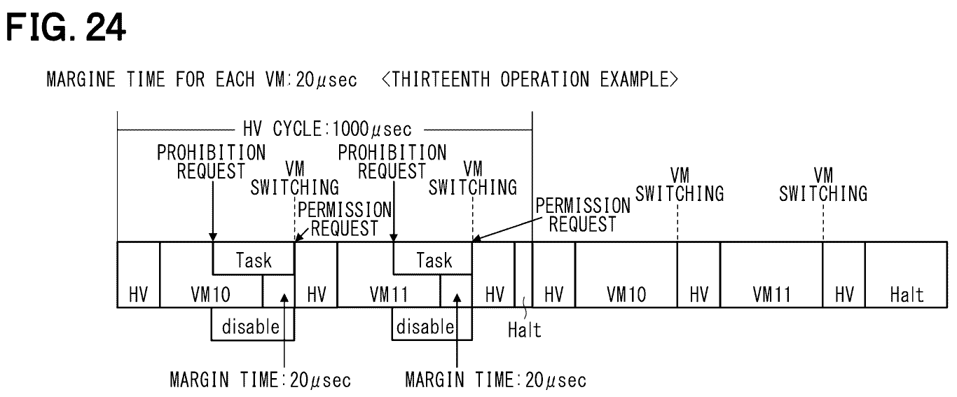

A thirteenth operation example shown in FIG. 24 assumes a case where the VMs 10 and 11 start executing a task in the middle of an operation time, and can complete the task without interruption. In this case, an operation of the VM 10 in the operation time is the same as that of the twelfth operation example. In this case, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process.

In this case, it is assumed that a time obtained by adding 20 μs, which is a margin time per VM corresponding to the VM 11, to the remaining time is longer than the set time. Then, the HV 2 executes the prohibition process at a time of receiving the prohibition request. In accordance with a start of the prohibition process, the VM 11, which is the operating machine, starts executing the task. In this case, the task is not completed at a time when the initial operation time allocated to the VM 11 elapses.

Therefore, the first processing unit 21 extends the operation time until the task being executed by the VM 11 is completed. In this case, 20 μs, which is the entire margin time per VM, is consumed to extend the operation time. According to such a thirteenth operation example, the VM 11 can extend its operation time up to the margin time per VM, and can continuously complete a task that is an uninterruptible process. The VM 11 transmits a permission request when completing the task. At a time of receiving the permission request, the HV 2 ends the prohibition process and executes the permission process. Thereby, the first processing unit 21 executes the switching process.

In this manner, even when the operation time is extended, a real-time property can be ensured by performing the VM switching immediately after the task is completed. As can be seen from the thirteenth operation example, according to the configuration of the present embodiment, since a margin time is given for each VM, a VM with a relatively high priority does not occupy a margin time. As a result, a margin time can be secured to the same extent for a VM with a relatively low priority.

### [2-14] Fourteenth Operation Example

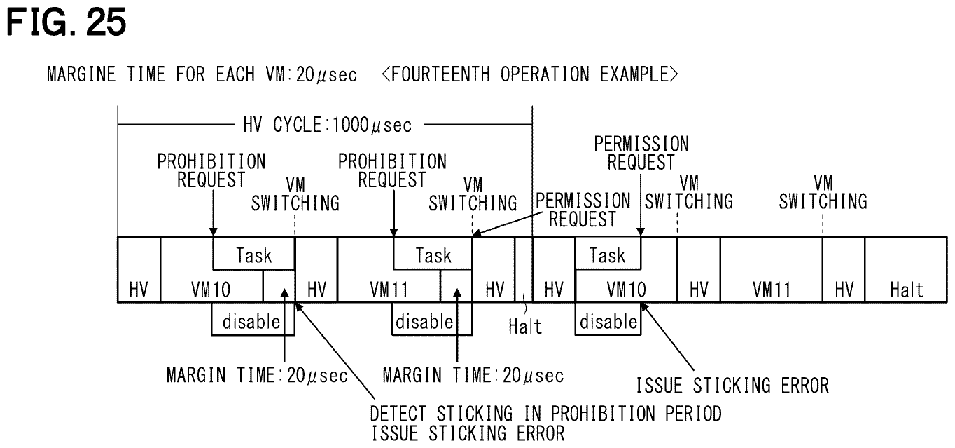

A fourteenth operation example shown in FIG. 25 assumes a case where the VM 10 starts executing a task in the middle of an operation time, and the task is not completed. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a time obtained by adding 20 μs, which is a margin time per VM corresponding to the VM 10, to the remaining time is longer than the set time. Then, the HV 2 executes the prohibition process at a time of receiving the prohibition request. In accordance with a start of the prohibition process, the VM 10, which is the operating machine, starts executing the task. In this case, the task is not completed at a time when the initial operation time allocated to the VM 10 elapses. Therefore, the first processing unit 21 extends the operation time until the task being executed by the VM 10 is completed.

However, in this case, it is assumed that the task is not completed even when 20 μs, which is the entire margin time per VM, is consumed and the operation time is extended due to some reason such as an abnormality or a failure. Then, the first processing unit 21 determines that the abnormality has occurred, and executes the notification process. In the notification process, the sticking error indicating that a state in which the VM switching is prohibited, that is, the prohibition period is stuck, has been detected is issued. Also, at this time, the first processing unit 21 performs the switching process with the VM switching prohibited in this manner.

In this case, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process. In this case, it is assumed that a time obtained by adding 20 μs, which is a margin time per VM corresponding to the VM 11, to the remaining time is longer than the set time. Then, the HV 2 executes the prohibition process at a time of receiving the prohibition request. In accordance with a start of the prohibition process, the VM 11, which is the operating machine, starts executing the task.

In this case, the task is not completed at a time when the initial operation time allocated to the VM 11 elapses. Therefore, the first processing unit 21 extends the operation time until the task being executed by the VM 11 is completed. In this case, 20 μs, which is the entire margin time per VM, is consumed to extend the operation time. The VM 11 transmits a permission request when completing the task. At a time of receiving the permission request, the HV 2 ends the prohibition process and executes the permission process. Thereby, the first processing unit 21 executes the switching process.

In the next HV cycle, the VM 10 resumes execution of the task from a time when the VM 10 itself is switched to the operating machine. In this case, the task executed by the VM 10 is completed at a time when a predetermined time has elapsed from a time when the VM 10 is switched to the operating machine. The VM 10 transmits the permission request when completing the task. At a time of receiving the permission request, the HV 2 ends the prohibition process and executes the permission process. Also, at this time, the HV 2 executes the notification process. Thereby, the sticking error is issued. Thereafter, at a time when the operation time allocated to the VM 10 elapses, the first processing unit 21 executes the switching process.

According to such a fourteenth operation example, the margin time per VM is set for each of the multiple VMs 10 and 11. Therefore, even in a case where one of the VMs 10 and 11 consumes the margin time per VM, when the other of the VMs 10 and 11 transmits the prohibition request, the operation time can be extended to an upper limit of the margin time per VM allocated to the VM, and the prohibition process can be executed.

According to the present embodiment described above, a margin time per VM is set for each of multiple VMs 10 and 11, and a first processing unit 21 extends an operation time so as to consume the required margin time from the margin time per VM corresponding to the operating machine. Thereby, regardless of whether a priority is high or low, all of the VMs 10 and 11 can use 20 μs, which is the margin time per VM, as the margin time. That is, according to the present embodiment, since the margin time is given for each VM, the VM with the relatively high priority does not occupy a margin time, and the margin time can be secured also for the VM with a relatively low priority.

### Third Embodiment

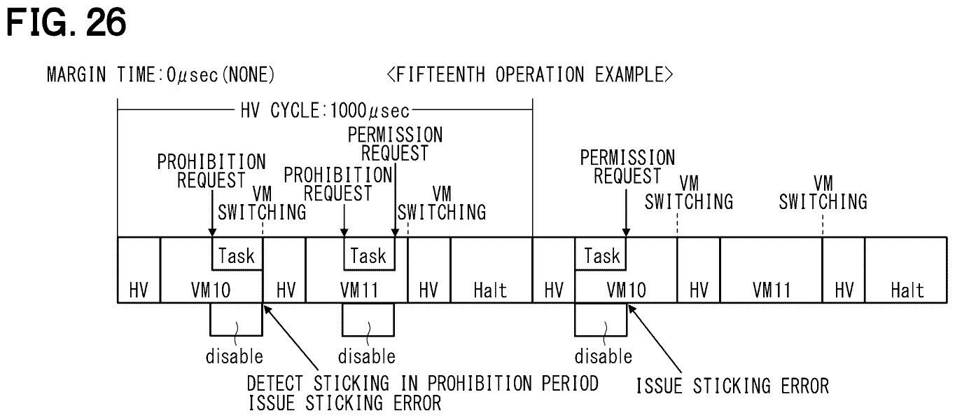

A third embodiment will be described below with reference to FIG. 26. In the present embodiment, the change is made to the processing content of a first processing unit 21 relative to the first embodiment. In the present embodiment, the first processing unit 21 does not extend an operation time during the prohibition period. That is, in the present embodiment, the margin time such as the total margin time or the margin time per VM is not set.

Next, an operation of the above configuration will be described.

### [2-15] Fifteenth Operation Example

A fifteenth operation example shown in FIG. 26 assumes a case where the VM 10 starts executing a task in the middle of an operation time, and the task is not completed. In this case, the VM 10 transmits the prohibition request to the HV 2 at a time when a predetermined time has elapsed from a time when the VM 10 itself is switched to the operating machine. When receiving the prohibition request transmitted from the VM 10, the HV 2 executes the determination process.

In this case, it is assumed that a remaining time is longer than a set time. Then, the HV 2 executes the prohibition process at a time of receiving the prohibition request. In accordance with a start of the prohibition process, the VM 10, which is the operating machine, starts executing the task. In this case, it is assumed that the task is not completed even when the operation time allocated to the VM 10 elapses due to some reason such as an abnormality or a failure. Then, the first processing unit 21 determines that the abnormality has occurred, and executes the notification process. In the notification process, the sticking error indicating that a state in which the VM switching is prohibited, that is, the prohibition period is stuck, has been detected is issued. Also, at this time, the first processing unit 21 executes the switching process with the VM switching prohibited in this manner.

In this case, the VM 11 transmits the prohibition request to the HV 2 at a time when a predetermined time has elapsed from a time when the VM 11 itself is switched to the operating machine. When receiving the prohibition request transmitted from the VM 11, the HV 2 executes the determination process. In this case, it is assumed that a remaining time is longer than a set time. Then, the HV 2 executes the prohibition process at a time of receiving the prohibition request. In accordance with a start of the prohibition process, the VM 11, which is the operating machine, starts executing the task. In this case, the task is completed before the operation time allocated to the VM 11 elapses. The VM 11 transmits the permission request when completing the task. At a time of receiving the permission request, the HV 2 ends the prohibition process and executes the permission process. Thereby, the first processing unit 21 executes the switching process.

In the next HV cycle, the VM 10 resumes execution of the task from a time when the VM 10 itself is switched to the operating machine. In this case, the task executed by the VM 10 is completed at a time when a predetermined time has elapsed from a time when the VM 10 is switched to the operating machine. The VM 10 transmits the permission request when completing the task. At a time of receiving the permission request, the HV 2 ends the prohibition process and executes the permission process. Also, at this time, the HV 2 executes the notification process. Thereby, the sticking error is issued. Thereafter, at a time when the operation time allocated to the VM 10 elapses, the first processing unit 21 executes the switching process.

According to the present embodiment described above, setting of a margin time such as a total margin time or a margin time per VM is not performed. According to the present embodiment, more operation times can be allocated to all the VMs 10 and 11 as compared with the above-described embodiments in which a margin time is set. In each of the above-described embodiments, an unused time of the set total margin time or margin time per VM may become a useless time, but in the present embodiment, such a useless time is not generated. In addition, according to the present embodiment, similarly to each of the above-described embodiments, sticking of the prohibition period can be detected, and the specific process that is not expected to be completed can be operated in the next HV cycle.

### Other Embodiments

The present disclosure is not limited to each embodiment described above and illustrated in the drawings, and can be arbitrarily modified, combined, or expanded without departing from the gist thereof. Numerical values and the like shown in each of the above-described embodiments are examples, and are not limited thereto.

The present disclosure is not limited to the HV 2 that controls time-division scheduling for each of the multiple VMs operating on the microcomputer 3 constituting the integrated ECU 1 mounted on a vehicle, and is applicable to general operation control devices that perform control for operating each of multiple VMs operating on a computer in a time-division manner by an operation time allocated in advance for each operation cycle.

Although the present disclosure has been described in accordance with the examples, it is understood that the present disclosure is not limited to such examples or structures. The present disclosure also encompasses various modifications and variations within the scope of equivalents. In addition, various combinations and forms, and further, other combinations and forms including only one element, more elements, or less elements are also within the scope and spirit of the present disclosure.

The controller and the method thereof described in the present disclosure may be implemented by a dedicated computer, which is configured by a processor and a memory programmed to execute one or multiple functions embodied by a computer program. Alternatively, the controller described in the present disclosure and the method thereof may be implemented by a dedicated computer configured as a processor with one or more dedicated hardware logic circuits. Alternatively, the controller and the method described in the present disclosure may be implemented by one or more special purpose computers, which are configured as a combination of a processor and a memory, which are programmed to perform one or more functions, and a processor which is configured with one or more hardware logic circuits. The computer program may also be stored on a computer-readable non-transitory tangible storage medium as instructions executed by a computer.

What is claimed is:

1. An operation control device configured to perform control for operating each of a plurality of virtual machines in a time-division manner by an operation time allocated in advance for each operation cycle, an operating machine being an operating virtual machine among the plurality of virtual machines, the operation control device comprising:
a first processor;
a first memory coupled to the first processor and storing first program instructions that when executed by the first processor cause the first processor to implement:
a first processing unit configured to execute a switching process of switching the operating machine; and
a second processing unit configured to execute a prohibition process of prohibiting execution of the switching process and a permission process of permitting execution of the switching process;
a second processor; and
a second memory coupled to the second processor and storing second program instructions that when executed by the second processor cause the second processor to implement the operating machine,
wherein
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process, the second processing unit executes the prohibition process when the remaining time is equal to or longer than the set time, and the second processing unit does not execute the prohibition process when the remaining time is less than the set time,
when receiving the permission request, the second processing unit executes the permission process,
during a prohibition period in which the prohibition process is executed, the first processing unit is configured to extend the operation time by a predetermined margin time,
the second processing unit executes the determination process in which a time from when the prohibition request is received to when an extended operation time elapses is set to the remaining time,
an available time is set for each operation cycle,
the first processing unit is capable of extending the operation time so as to consume a required margin time from the available time, and
in a case where an operation of an operating machine that operates last in the operation cycle is started, when there is a surplus in the available time, the first processing unit is capable of allocating at least a part of the surplus to the operation time of the operating machine that operates last.

2. The operation control device according to claim 1, wherein
in a case where the specific process is not completed at a time when the operation time elapses in the prohibition period, the first processing unit determines that an abnormality has occurred, and executes one or both of the switching process and a notification process of notifying an outside of the abnormality.

3. The operation control device according to claim 1, wherein
in a case where the specific process is not completed at a time when the operation time elapses in the prohibition period, the first processing unit
determines that an abnormality has occurred, and
executes a notification process of notifying an outside of the abnormality when receiving the permission request in a subsequent operation cycle.

4. The operation control device according to claim 1, wherein the set time is set in advance for each of the plurality of virtual machines.

5. The operation control device according to claim 1, wherein
when receiving the prohibition request, the second processing unit sets the set time based on a time required for the specific process started by the operating machine that has transmitted the prohibition request.

6. The operation control device according to claim 1, wherein
when the prohibition process is not executed after the operating machine transmits the prohibition request, the first processing unit
sets a state of the operating machine to a standby state or
sets the state of the operating machine to a state where a process different from the specific process is executable,
during a period until the switching process is executed.

7. An operation control device configured to perform control for operating each of a plurality of virtual machines in a time-division manner by an operation time allocated in advance for each operation cycle, an operating machine being an operating virtual machine among the plurality of virtual machines, the operation control device comprising:
a first processor;
a first memory coupled to the first processor and storing first program instructions that when executed by the first processor cause the first processor to implement:
a first processing unit configured to execute a switching process of switching the operating machine; and
a second processing unit configured to execute a prohibition process of prohibiting execution of the switching process and a permission process of permitting execution of the switching process;
a second processor; and
a second memory coupled to the second processor and storing second program instructions that when executed by the second processor cause the second processor to implement the operating machine,
wherein
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process, the second processing unit executes the prohibition process when the remaining time is equal to or longer than the set time, and the second processing unit does not execute the prohibition process when the remaining time is less than the set time,
when receiving the permission request, the second processing unit executes the permission process, and
when the prohibition process is not executed after the operating machine transmits the prohibition request, the first processing unit causes the operating machine to repeatedly transmit the prohibition request until the prohibition process is executed.

8. An operation control device configured to perform control for operating each of a plurality of virtual machines in a time-division manner by an operation time allocated in advance for each operation cycle, an operating machine being an operating virtual machine among the plurality of virtual machines, the operation control device comprising:
a first processor;
a first memory coupled to the first processor and storing first program instructions that when executed by the first processor cause the first processor to implement:
a first processing unit configured to execute a switching process of switching the operating machine; and
a second processing unit configured to execute a prohibition process of prohibiting execution of the switching process and a permission process of permitting execution of the switching process;
a second processor; and
a second memory coupled to the second processor and storing second program instructions that when executed by the second processor cause the second processor to implement the operating machine,
wherein
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process, the second processing unit executes the prohibition process when the remaining time is equal to or longer than the set time, and the second processing unit does not execute the prohibition process when the remaining time is less than the set time,
when receiving the permission request, the second processing unit executes the permission process, and
in a case where the prohibition process is not executed after the operating machine transmits the prohibition request, the first processing unit executes the switching process before the operation time allocated to the operating machine elapses or at a time when the operation time allocated to the operating machine has elapsed.

9. The operation control device according to claim 7, wherein
during a prohibition period in which the prohibition process is executed, the first processing unit is configured to extend the operation time by a predetermined margin time,
the second processing unit executes the determination process in which a time from when the prohibition request is received to when an extended operation time elapses is set to the remaining time,
an available time is set for each of the plurality of virtual machines, and
the first processing unit is configured to extend the operation time so as to consume a required margin time from the available time for the operating machine.

10. A non-transitory computer-readable storage medium storing an operation control program executed by an operation control device configured to perform control for operating each of a plurality of virtual machines in a time-division manner by an operation time allocated in advance for each operation cycle, an operating machine being an operating virtual machine among the plurality of virtual machines, the operation control program comprising:
a first process of executing a switching process of switching the operating machine; and
a second process of executing a prohibition process of prohibiting execution of the switching process and a permission process of permitting execution of the switching process,
wherein
the operating machine
transmits a prohibition request when starting a specific process, which is a process requiring continuous execution, and
transmits a permission request when completing the specific process,
the second process includes:
when receiving the prohibition request, executing a determination process of determining whether a remaining time, which is a time from a reception time to a time when the operation time elapses, is equal to or longer than a predetermined set time;
in response to a result of the determination process,
executing the prohibition process when the remaining time is equal to or longer than the set time, and
not executing the prohibition process when the remaining time is less than the set time; and
when receiving the permission request, executing the permission process,
during a prohibition period in which the prohibition process is executed, the first process extends the operation time by a predetermined margin time,
the second process executes the determination process in which a time from when the prohibition request is received to when an extended operation time elapses is set to the remaining time,
an available time is set for each operation cycle,
the first process is capable of extending the operation time so as to consume a required margin time from the available time, and
in a case where an operation of an operating machine that operates last in the operation cycle is started, when there is a surplus in the available time, the first process is capable of allocating at least a part of the surplus to the operation time of the operating machine that operates last.

11. A non-transitory computer-readable storage medium storing an operation control program executed by an operation control device configured to perform control for operating each of a plurality of virtual machines in a time-division manner by an operation time allocated in advance for each operation cycle, an operating machine being an operating virtual machine among the plurality of virtual machines, the operation control program comprising:
a first process of executing a switching process of switching the operating machine; and
a second process of executing a prohibition process of prohibiting execution of the switching process and a permission process of permitting execution of the switching process,
wherein
the operating machine
transmits a prohibition request when starting a specific process, which is a process requiring continuous execution, and
transmits a permission request when completing the specific process,
the second process includes:
when receiving the prohibition request, executing a determination process of determining whether a remaining time, which is a time from a reception time to a time when the operation time elapses, is equal to or longer than a predetermined set time;
in response to a result of the determination process,
executing the prohibition process when the remaining time is equal to or longer than the set time, and
not executing the prohibition process when the remaining time is less than the set time; and
when receiving the permission request, executing the permission process, and
when the prohibition process is not executed after the operating machine transmits the prohibition request, the first process causes the operating machine to repeatedly transmit the prohibition request until the prohibition process is executed.

12. A non-transitory computer-readable storage medium storing an operation control program executed by an operation control device configured to perform control for operating each of a plurality of virtual machines in a time-division manner by an operation time allocated in advance for each operation cycle, an operating machine being an operating virtual machine among the plurality of virtual machines, the operation control program comprising:
a first process of executing a switching process of switching the operating machine; and
a second process of executing a prohibition process of prohibiting execution of the switching process and a permission process of permitting execution of the switching process,
wherein the operating machine
transmits a prohibition request when starting a specific process, which is a process requiring continuous execution, and
transmits a permission request when completing the specific process,
the second process includes:
when receiving the prohibition request, executing a determination process of determining whether a remaining time, which is a time from a reception time to a time when the operation time elapses, is equal to or longer than a predetermined set time;
in response to a result of the determination process,
executing the prohibition process when the remaining time is equal to or longer than the set time, and
not executing the prohibition process when the remaining time is less than the set time; and
when receiving the permission request, executing the permission process, and
in a case where the prohibition process is not executed after the operating machine transmits the prohibition request, the first process executes the switching process before the operation time allocated to the operating machine elapses or at a time when the operation time allocated to the operating machine has elapsed.

13. An electronic control unit comprising:
a computer;
a plurality of virtual machines operating on and implemented by the computer; and
a processor;
a memory coupled to the processor and storing program instructions that when executed by the processor cause the processor to implement an operation control device configured to control each of the plurality of virtual machines to operate in a time-division manner for a predetermined operation time for each operation cycle,
wherein
an operating machine is an operating virtual machine among the plurality of virtual machines,
the processor is further caused to implement:
a first processing unit configured to execute a switching process of switching the operating machine,
a second processing unit configured to execute a prohibition process of prohibiting execution of the switching process and a permission process of permitting execution of the switching process,
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process,
the second processing unit executes the prohibition process when the remaining time is equal to or longer than the set time, and
the second processing unit does not execute the prohibition process when the remaining time is less than the set time,
when receiving the permission request, the second processing unit executes the permission process,
during a prohibition period in which the prohibition process is executed, the first processing unit is configured to extend the operation time by a predetermined margin time,
the second processing unit executes the determination process in which a time from when the prohibition request is received to when an extended operation time elapses is set to the remaining time,
an available time is set for each operation cycle,
the first processing unit is capable of extending the operation time so as to consume a required margin time from the available time, and
in a case where an operation of an operating machine that operates last in the operation cycle is started, when there is a surplus in the available time, the first processing unit is capable of allocating at least a part of the surplus to the operation time of the operating machine that operates last.

14. An electronic control unit comprising:
a computer;
a plurality of virtual machines operating on and implemented by the computer; and
a processor;
a memory coupled to the processor and storing program instructions that when executed by the processor cause the processor to implement an operation control device configured to control each of the plurality of virtual machines to operate in a time-division manner for a predetermined operation time for each operation cycle,
wherein
an operating machine is an operating virtual machine among the plurality of virtual machines,
the processor is further caused to implement:
a first processing unit configured to execute a switching process of switching the operating machine,
a second processing unit configured to execute a prohibition process of prohibiting execution of the switching process and a permission process of permitting execution of the switching process,
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process,
the second processing unit executes the prohibition process when the remaining time is equal to or longer than the set time, and
the second processing unit does not execute the prohibition process when the remaining time is less than the set time,
when receiving the permission request, the second processing unit executes the permission process, and
when the prohibition process is not executed after the operating machine transmits the prohibition request, the first processing unit causes the operating machine to repeatedly transmit the prohibition request until the prohibition process is executed.

15. An electronic control unit comprising:
a computer;
a plurality of virtual machines operating on and implemented by the computer; and
a processor;
a memory coupled to the processor and storing program instructions that when executed by the processor cause the processor to implement an operation control device configured to control each of the plurality of virtual machines to operate in a time-division manner for a predetermined operation time for each operation cycle,
wherein
an operating machine is an operating virtual machine among the plurality of virtual machines,
the processor is further caused to implement:
a first processing unit configured to execute a switching process of switching the operating machine,
a second processing unit configured to execute a prohibition process of prohibiting execution of the switching process and a permission process of permitting execution of the switching process,
the operating machine
transmits a prohibition request when starting a specific process, which is a process requiring continuous execution, and
transmits a permission request when completing the specific process,
when receiving the prohibition request, the second processing unit executes a determination process of determining whether a remaining time, which is a time from a reception time to a time when the operation time elapses, is equal to or longer than a predetermined set time,
in response to a result of the determination process,
the second processing unit executes the prohibition process when the remaining time is equal to or longer than the set time, and
the second processing unit does not execute the prohibition process when the remaining time is less than the set time,
when receiving the permission request, the second processing unit executes the permission process, and
in a case where the prohibition process is not executed after the operating machine transmits the prohibition request, the first processing unit executes the switching process before the operation time allocated to the operating machine elapses or at a time when the operation time allocated to the operating machine has elapsed.

16. The operation control device according to claim 1, wherein
the operating machine executes the specific process during the prohibition period, which is a period during which the prohibition process is executed.

17. The non-transitory computer-readable storage medium storing the operation control program according to claim 10, wherein
the operating machine executes the specific process during the prohibition period, which is a period during which the prohibition process is executed.

18. The electronic control unit according to claim 14, wherein
the operating machine executes the specific process during a prohibition period, which is a period during which the prohibition process is executed.
